(19) United States
(12) Patent Application Publication
(10) Pub. No.: US 2013/0104443 A1
(43) Pub. Date: May 2, 2013

(54) DECOY APPARATUS

(71) Applicant: Marty Cramer, Ontario, OR (US)

(72) Inventor: Marty Cramer, Ontario, OR (US)

(21) Appl. No.: 13/285,734

(22) Filed: Oct. 31, 2011

(51) Int. Cl. A01M 31/06

(52) U.S. Cl. 43/2

(57) ABSTRACT

A decoy apparatus configured to simulate the movement of wild game. The decoy apparatus includes a base member having a plurality of leg mounting ports. The decoy apparatus includes a hub having an axle extending through and below the base member. The hub includes a mounting face coupled to the axle and disposed above the base member. The decoy apparatus includes a spool selectably coupleable to the axle of the hub. The decoy apparatus includes a plurality of arms selectably coupleable to the mounting face of the hub. The decoy apparatus includes a plurality of decoys selectably coupleable to the plurality of arms and configured to resemble live wild game. The decoy apparatus includes a plurality of leg members configured to couple to the plurality of leg mounting ports. The decoy apparatus includes a motor module configured to provide selectable motorized movement of the hub.

### BACKGROUND OF THE INVENTION

1. Field of the Invention

The present invention relates to decoy devices, specifically animal decoy devices for attracting animals for hunting and/or other sporting activities.

2. Description of the Related Art

In the related art, it has been known to use decoy devices to attract animals for the purpose of hunting, trapping, and picture taking among other activities. Some decoy devices are designed to emulate particular characteristics of an animal to attract the animal, the characteristics may include appearance, sound, smell, position and/or movement among other characteristics. Decoys made from vegetation (such as cattails) were used by Native Americans. Live birds tied to cords and/or weights have been used but are currently illegal. Decoys carved from wood have been used, especially as floating decoys in bodies of water.

Generally, hunters and others who would like to attract animals will set up a blind or some kind of protective, hidden area where the person can hide while using the decoys to attract animals. Decoys must often be carried for long distances and need to be set-up before they can be used. Some improvements have been made in the field. Examples of references related to the present invention are described below in their own words, and the supporting teachings of each reference are incorporated by reference herein:

United States Patent Application Number 2009/0235571 of Wyant et al. entitled “Apparatus for revolving decoys about a vertical axis” directed to an apparatus comprising a motor, a traverse support beam, a first support rod, and a second support rod. The motor is operative to rotate an axle. The traverse support beam is rotationally coupled to this axle and has a first end and a second end. The first support rod is coupled to the first end of the traverse support beam and is adapted to support a first decoy. Finally, the second support rod is coupled to the second end of the traverse support beam and is adapted to support a second decoy.

United States Patent Application Number 2009/0260274 of Jay Rogers entitled “Decoy Motion Technology” directed to a decoy system for use in hunting. The system includes a central base with a motor which moves a rotating member of the base. Several arms of a predetermined length are connected to the rotating member of the base, and satellite decoy elements are connected to outer ends of the arms. A central decoy element is optionally connected to the center of the rotating member. The decoy members may be birds, for example doves.

U.S. Pat. No. 7,536,823 granted to entitled “Flying bird decoy and method” directed to a flying bird decoy for attracting wildlife wherein flying bird decoys may be supported on each end of one or more rotatable rods or arms, with wings that selectively fold and flap up and down in life-like, actual flying, landing and take-off movements. The bird decoys simulate foraging, predatory or waterfowl birds and in one embodiment a pair of the bird decoys are mounted on the ends of a rod or arm(s) rotatably mounted on a pole or stake support, using throat mounts. In another embodiment the bird decoys are secured to the ends of the arm(s) at the head without the use of throat mounts, for flying in a circle on the arm(s) to attract the wildlife. In a further embodiment one or both of the bird decoys are configured to simulate one of the above bird groups and fly to generate rotation of the arm(s), with one wing folded and the other flapping to simulate injury or distress. A method for attracting wildlife using flying bird decoys which simulate dove, quail, crows, hawks, ducks, geese or the like, and includes the steps of mounting the bird decoys on a rotatable arm or arms carried by a pole or stake support and causing one or both of the wings to flap, thus causing the bird decoys to fly or vibrate in a circle around the support.

U.S. Pat. No. 6,357,159 granted to Bowling entitled “Decoy apparatus for attracting animals” directed to a decoy moving apparatus for attracting animals including a set of reels attached to a clutch system which is workable on an automated drive motor system. The clutch system works to engage and disengage the reels to take-on/take-off line which is extending from the reels to at least one stake or decoy anchor reference point, wherein the line is attached to a decoy pulled between the reels and one or more anchors, whereby the take-on/take-off of the line with the decoy apparatus moves the decoy back and forth and/or rotates the decoy on its axis. The decoy may float in water, mounted to a sled type mounting base, or suspended from a wire, depending upon the habitat of the animal to be attracted to the viewer.

U.S. Pat. No. 7,562,487 granted to Thomas, entitled “Decoy movement system for simulating life-like movement of animal species” directed to a decoy mounting and movement system for mounting a hollow animal species decoy and for simulating life-like movement of the animal species between a rest position and a vertically pivoted position which simulates feeding by the animal species having a decoy mounting stake formed of an elongate upper stake section and an elongate lower stake section interconnected via an elongate vertical return spring capable of bending along its length to create an angle between the upper and lower stake sections, the upper stake section dimensioned for insertion into the hollow of the decoy through an opening in its underside in communication with the hollow of the decoy, wherein the fulcrum for vertical pivoting of the decoy is positioned at the lower end of the upper stake section and the ratio D′/D is less than 0.25, wherein D′ is the distance between the underside of the decoy and the fulcrum for vertical pivoting, and D is the length of the upper stake section.

The inventions heretofore known suffer from a number of disadvantages which include being limited in functionality, being limited in movement, being expensive, being difficult to control, being complex to set up, being bulky, being burdensome to use, being ineffective, being inefficient, being limited in use, tipping over during use, being unstable, taking too long to set-up and/or break-down, being difficult to customize, tangling, providing unrealistic movement, being fragile, and/or being difficult to modify.

What is needed is a decoy apparatus that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available decoy apparatuses. Accordingly, the present invention has been developed to provide a decoy apparatus that mimics the movement of wild game while controlling the decoy apparatus from a remote location.

According to one embodiment of the invention, there is a decoy apparatus configured to simulate the movement of wild game. The decoy apparatus may include a base member that may include a plurality of leg mounting ports. The decoy apparatus may include a hub that may be disposed above the base member and may be shaped and sized to be able to extend therethrough. The hub may include an axle that may extend through and below the base member. The hub may include a mounting face that may be coupled to the axle and may be disposed above the base member.

The decoy apparatus may include a spool that may be selectably coupleable to the axle of the hub and may be sized to be able to be disposed underneath the base member without obstructing the operation of the leg mounting ports thereof and a plurality of leg members extending therefrom. The axle may include a securing member that may be disposed therein and may be configured to securely couple the spool thereto.

The decoy apparatus may include a plurality of arms that may be selectably coupleable to the mounting face of the hub and may be shaped to extend outwardly therefrom when so attached. One of the plurality of arms may include a plurality of selectably connectable arm segments of varying length. The plurality of arms each may include an angled extension arm that may be coupled to the mounting face of the hub, wherein the angled extension arm may be oriented at an angle substantially different from an angle of another extension arm of the apparatus.

The decoy apparatus may include a plurality of decoys that may be selectably coupleable to an end of the plurality of arms and may be configured to resemble live wild game. The decoy apparatus may include a plurality of leg members that may be configured to couple to the plurality of leg mounting ports of the base member. The decoy apparatus may include a wild game cradle that may be configured to support a decoy when coupled to an arm.

The decoy apparatus may include a motor module that may be coupled to the axle of the hub and may be disposed underneath the base member and may be configured to provide selectable motorized movement of the hub. The motor module may include a remote control module that may include a wireless receiver that may be configured to activate the motor module from signals received from a remote location. The motor module may include a power module that may be configured to provide power to the apparatus.

The decoy apparatus may include a plurality of stakes that may be selectably coupleable to an end of the plurality of leg members and may be configured to couple the plurality of leg members to the ground. The decoy apparatus may include a plurality of guide members that may be coupled to a length of cord at least partially wound about the spool and may be configured to guide a length of cord from the spool.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a perspective view of a decoy apparatus in situ, according to one embodiment of the invention;

FIG. 2 illustrates an exploded view of a decoy apparatus, according to one embodiment of the invention;

FIG. 3 illustrates a top plan view of a base member of a decoy apparatus, according to one embodiment of the invention;

FIG. 4 illustrates a side elevational view of a base member of a decoy apparatus, according to one embodiment of the invention;

FIG. 5 illustrates a perspective view of a hub of a decoy apparatus, according to one embodiment of the invention;

FIG. 6 illustrates a perspective view of a motor module and remote control of a decoy apparatus, according to one embodiment of the invention;

FIG. 7 illustrates a perspective view of a spool of a decoy apparatus, according to one embodiment of the invention;

FIG. 8 illustrates a perspective view of a plurality of arms of a decoy apparatus, according to one embodiment of the invention;

FIG. 9 illustrates a perspective view of an extension arm of a decoy apparatus, according to one embodiment of the invention; and

FIG. 10 illustrates a perspective view of a coupling arm of a decoy apparatus, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

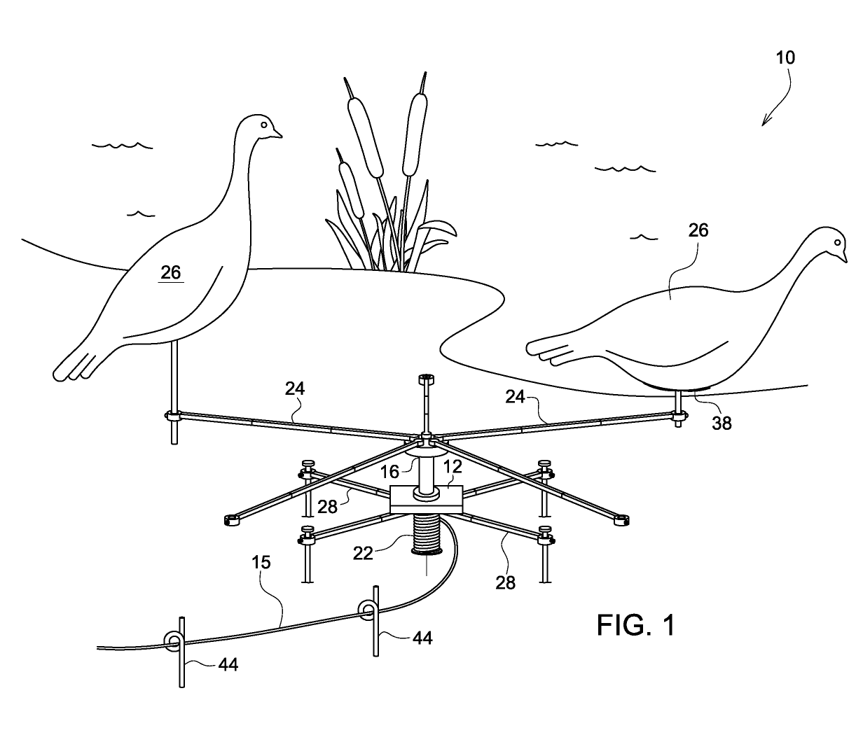

FIG. 1 illustrates a perspective view of a decoy apparatus, according to one embodiment of the invention. There is shown a decoy apparatus 10 including a base member 12 coupled to each of a hub 16 and a spool 22, with the hub and spool functionally coupled to each other through an aperture through the base member such that rotation of the spool induces rotation of the hub. The hub 16 is coupled to a plurality of arms 24 which are coupled to a plurality of decoys 26. The base member 12 is coupled to a plurality of leg members 28 which provide support and stability to the apparatus. The illustrated apparatus rests on the ground near a body of water and includes decoys of waterfowl.

The illustrated decoy apparatus 10 is configured to simulate the movement of wild game. Wild game may include but not limited to ducks, geese, turkeys, or any other type of bird or wild game. The decoy apparatus 10 includes a base member 12 coupled to a plurality of leg members 28 extending outwardly therefrom. The base member 12 includes an aperture (not shown) through which the illustrated hub and spool are coupled and thereby coupled to the base member. The base member forms an attachment locus for the leg members in a manner that functionally separates motion of the spool and hub from the leg members while placing the spool below the leg members, thereby increasing stability of the apparatus.

The illustrated decoy apparatus 10 includes a hub 16 disposed above the base member 12 and shaped and sized to be able to extend therethrough. The illustrated hub 16 includes a shaft coupled to a mounting face whereby arms are coupled thereto. The shaft extends downwardly from the mounting face and through a support collar that supports the hub/spool structure while permitting rotation thereof free of the base. The arms extending from the mounting face are coupled thereto in a manner that when the hub rotates, so do the arms.

The illustrated decoy apparatus 10 includes a spool 22 selectably coupleable to the hub 16 and is sized to be able to be disposed underneath the base member 12 such that it may rotate freely. The illustrated spool includes a cord wound thereabout between guide flanges such that rotation of the spool winds/unwinds the cord and tension on the cord translates to an application of angular force on the spool, thereby causing it to rotate. While a single cord is illustrated, it is understood that a plurality of cords may be utilized, such as but not limited to counter-winding cords such that pulling one cord tends to wind the other while unwinding the pulled cord and vice versa. The illustrated cord (string, twine, thread, line, etc.) may include one or more of woven fiber, filament, chain, ribbon, and the like and combinations thereof that may be made of metal, plastic, organic fibers, and the like and combinations thereof.

The decoy apparatus 10 includes a plurality of arms 24 selectably coupleable to the hub 16 and is sized and shaped to extend outwardly therefrom when so attached. The illustrated arms include arm sections coupled to each other to provide a desired length and/or configuration. Each of the illustrated arms includes an inner member (arm) that includes structure for coupling to the mounting face and structure opposite for coupling to another arm. Each of the illustrated arms includes an arm extension member (extension arm) coupled to an inner member and providing a length extension of a desired and/or predetermined amount thereto. The arm extension members include structure for coupling to other arm members on each end thereof. Each of the illustrated arms includes a decoy coupling member (coupling arm) coupled to an arm extension member and also including structure for coupling to a decoy. Each of the illustrated arms terminates in the decoy coupling member, though only two of the five illustrated arms include decoys coupled thereto.

The decoy apparatus 10 includes a plurality of decoys 26 selectably coupleable to an end of the plurality of arms 24. The plurality of decoys are configured to resemble live wild game and may include decorative devices that share characteristics with objects and/or creatures that are attractive to animals. Such may include but are not limited to: silhouette decoys, full body decoys, shell decoys, floater decoys, windsock decoys, flag decoys, and/or motorized decoys and the like and combinations thereof. The decoy apparatus 10 includes a plurality of leg members 28 configured to couple to the base member 12 and extend outwardly therefrom. The decoy apparatus 10 includes a wild game cradle 38 configured to support a decoy 26 when coupled there. A decoy may couple to a decoy apparatus by rigid connection, merely nestling in a holder, and/or by use of a coupling device and/or structure such as but not limited to snaps, bolts, pins, straps, screws, ropes, fasteners, and the like and combinations thereof.

The illustrated decoy apparatus 10 includes a plurality of guide members 44 that are set into the ground and coupled to a length of cord 15 at least partially wound about the spool 22. The plurality of guide members 44 are configured to couple to the ground and guide the length of cord 15 from the spool 22 away from the decoy apparatus 10. Advantageously, the guide members permit a change in direction of force that is applied as the cord is pulled such that a hunter/user may change positions without having to completely reset the apparatus. Further, guide members will absorb an amount of impulse force when the cord is initially pulled, thereby reducing any tendency for the apparatus itself to display a “pulse” by shaking the decoys when the cord is initially pulled. The illustrated guide members include curved members that form eyelets through which the cord extends. Wherein the eyelets are incomplete circles, more like spirals, it is a simple matter to “string” the eyelets by manipulating the cord about the spiral without having to run the ends of the cord entirely through the eyelets. Accordingly, it is simple and easy to reposition the guide members and “re-string” them when done.

In operation, a user places the apparatus in a location where it is desired to attract animals attracted to pre-selected decoys. The apparatus is assembled as needed on location or prior thereto, including coupling one or more decoys to the apparatus. During setup, the user may selectably configure the arms as possible according to the desired lengths, angles, positions, and orientations with respect to the hub. Such may be accomplished by mixing and matching arm segments and/or adjusting couplings there between and couplings with the mounting face. The user may also mix and match the various decoys with specific arm setups. Accordingly, a user may mimic specific positions, movements, orientations, and relationships between and amongst the decoys and the animals that they represent.

The cord is extended to a location where the user may be hidden or distanced from the apparatus and guides may be placed to facilitate the use thereof. The user may then pull the cord, which causes the spool to rotate, thereby rotating the hub and mounting face. Such causes the arms to move which move the attached decoys. The user may control the speed of movement of the decoys by adjusting the tension of the cord. Legs may be set on or into the ground. Where they are set into the ground, they may penetrate the same and provide enhanced resistance to moving the apparatus as tension is applied to the cord. Such operation/tension may be accomplished manually and/or be mechanically/electronically assisted, such as but not limited to wherein a motor is coupled to the hub or spool, directly or indirectly.

Accordingly, a user may operate the apparatus from a remote location, such as but not limited to a nearby blind. The user may selectably cause the apparatus to move/rotate in a realistic manner as desired and thereby attract game. Wherein the user desires to move to a different location, and/or leave the area, setup and take-down of the apparatus is simple and easy.

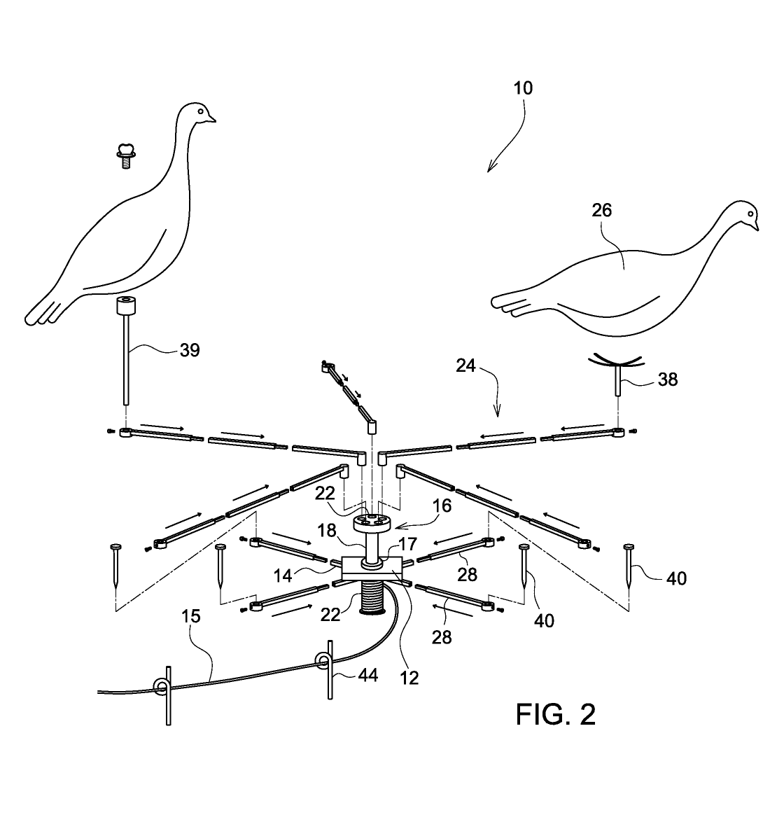

FIG. 2 illustrates an exploded view of a decoy apparatus, according to one embodiment of the invention. There is shown a decoy apparatus 10 including a base member 12, a hub 16, a spool 22, a plurality of arms 24, a plurality of decoys 26, and a plurality of leg members 28.

The illustrated decoy apparatus 10 is configured to simulate the movement of wild game. The decoy apparatus 10 includes a base member 12 that includes a plurality of leg mounting ports 14. The plurality of leg mounting ports 14 are disposed about a bottom surface of the base member and configured to extend outwardly therefrom. The decoy apparatus 10 includes a hub 16 disposed above the base member 12 and shaped and sized to be able to extend therethrough. The hub 16 includes an axle 18 coupled to a collar 17 and extending therethrough. The collar 17 supports the hub/axle above the base member 12 and permits the axle to rotate freely inside the base member 12. The collar may include one or more bearings, flanges, support members and the like and combinations thereof such that it accomplishes its purposes. The axle 18 is configured to extend through and below the base member 12. The axle 18 is positioned perpendicularly to the base member 12. The hub 16 includes a mounting face 22 that is disposed above the axle 18 and is configured to receive a plurality of arms 24. The illustrated mounting face is a short cylindrical member including a plurality of cavities extending into a top surface. Such cavities form mounting ports whereby arm segments may be attached thereto. It is understood that a mounting face may include any number and/or kind of coupling interfaces/devices for coupling with matched arm segments, such as but not limited to loops, cavities, hooks, brackets, apertures, and the like and combinations thereof.

The illustrated decoy apparatus 10 includes a spool 22 selectably coupleable to the axle 18 of the hub 16. The illustrated spool 22 is sized and shaped to be able to be disposed underneath the base member 12 without obstructing the operation of the leg mounting ports 14. In general, the spool would be at least shorter than the effective vertical length of the leg members and associated stakes 40 or other similar structures. Accordingly, the spool is not in friction contact with the ground during use. The spool 22 is configured to extend through the base member 12, within the axle 18 and couple thereto.

The decoy apparatus 10 may include a plurality of arms 24 selectably coupleable to the mounting face 22 of the hub 16. The plurality of arms 24 are configured to be shaped and sized to extend outwardly from the hub 16 when so attached. The illustrated plurality of arms 24 include modular components or segments configured to selectably couple together to create an extension arm 24 to support a decoy 26. The decoy apparatus 10 includes a plurality of decoys 26 selectably coupleable to an end of an arm 24. The plurality of decoys 26 are configured to resemble live wild game and mimic wild game movement to attract other wild game. The decoy apparatus 10 includes a plurality of leg members 28 configured to couple to the base member 12. The illustrated decoy apparatus 10 includes a wild game cradle 38 configured to support a decoy 26 when coupled to the arm 24. Further, there is shown a decoy mounting post shaped and sized to extend through an aperture through a bottom of a decoy, thereby resting near a top surface of the decoy on an inside of the decoy, whereby a screw may be secured through a top surface of the decoy to the mounting post, thereby securing the decoy to the apparatus. The mounting post may be secured through an eyelet of the arm, such as but not limited to being trapped therein by a pinning screw (a screw set within a threaded aperture generally orthogonal to an axis of an eyelet and positioned, sized and configured to selectably press against a surface of an object inserted into the eyelet and thereby trap the object by friction at a specific position and/or orientation within the eyelet).

The decoy apparatus 10 includes a plurality of stakes 40 selectably coupleable to the plurality of leg members 28. The plurality of stakes 40 are configured to couple the plurality of leg members 28 to the ground, thereby securing the decoy apparatus 10 thereto. The illustrated stakes are coupled to the leg members by eyelets including pinning screws. The decoy apparatus 10 includes a plurality of guide members 44 configured to guide a length of cord 15, at least partially wound about the spool 22, away from the decoy apparatus 10.

As illustrated in FIG. 2, the decoy apparatus 10 includes a plurality of arms 24 and a plurality of leg members 28. The plurality of arms 24 and the plurality of leg members 28 include matching coupling structures configured to permit the members to generally be interchangeable, and including varying lengths to provide a balanced and/or versatile decoy apparatus 10 during use.

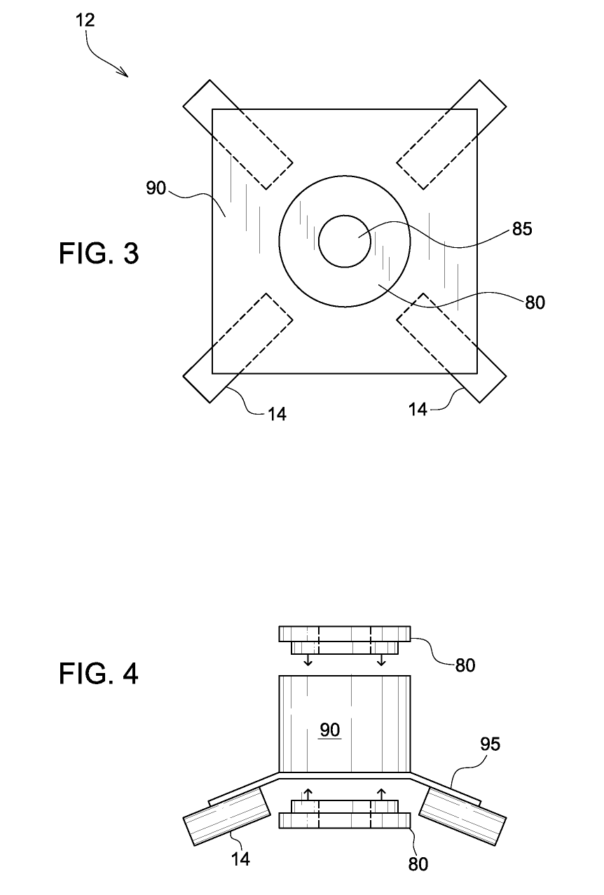

FIG. 3 illustrates a top plan view of a base member of a decoy apparatus, according to one embodiment of the invention. There is shown a base member 12 including a plurality of leg mounting ports 14, a collar 80, an aperture 85, and a base plate 90.

The illustrated base member 12 includes a plurality of leg mounting ports 14. The plurality of leg mounting ports 14 are coupled to a bottom surface of a base plate 90 of the base member 12. The illustrated plurality of leg mounting ports 14 are disposed substantially parallel to the base plate 90 and configured to extend therefrom. The illustrated leg mounting ports 14 are disposed about the corners of the base plate and configured to extend outwardly therefrom. The leg mounting ports 14 are disposed in a uniform design configured to provide stability to the decoy apparatus during use. The base member 12 includes an aperture 85 configured to receive and support an axle of a hub of the decoy apparatus. The base member 12 includes a collar 80 including ball bearings (and/or other friction reducing structures and/or devices) disposed about the aperture 85 and/or disposed between the collar and the base plate 90 and configured to provide friction free rotation of the hub when coupled thereto.

FIG. 4 illustrates a side elevational view of a base member of a decoy apparatus, according to one embodiment of the invention. There is shown a base member 12 including a plurality of leg mounting ports 14, a pair of collars 80, a base plate 90, and an angled base plate 95.

The illustrated base member 12 includes a plurality of leg mounting ports 14 disposed beneath an angled base plate 95. The plurality of leg mounting ports 14 are sized and shaped to receive a plurality of leg members. The angled base plate 95 is configured to direct a plurality of legs in a diagonally downward direction. The angled base plate 95 is coupled to a riser cylinder 90, wherein the riser cylinder 90 is disposed above the angled base plate 95 and provides a heightened surface for the upper collar 80. The base member 12 includes a pair of collars 80, one of the collars 80 is disposed beneath the angled base plate 95 and the other collar 80 is disposed above the base plate 90. The pair of collars 80 are configured to provide friction free rotation of a hub and a plurality of arms and decoys and to a spool of the decoy apparatus. Such collars may include one or more friction reducing structures and/or devices including but not limited to ball bearings, lubricated surfaces, magnetically levitated surfaces, and the like and combinations thereof.

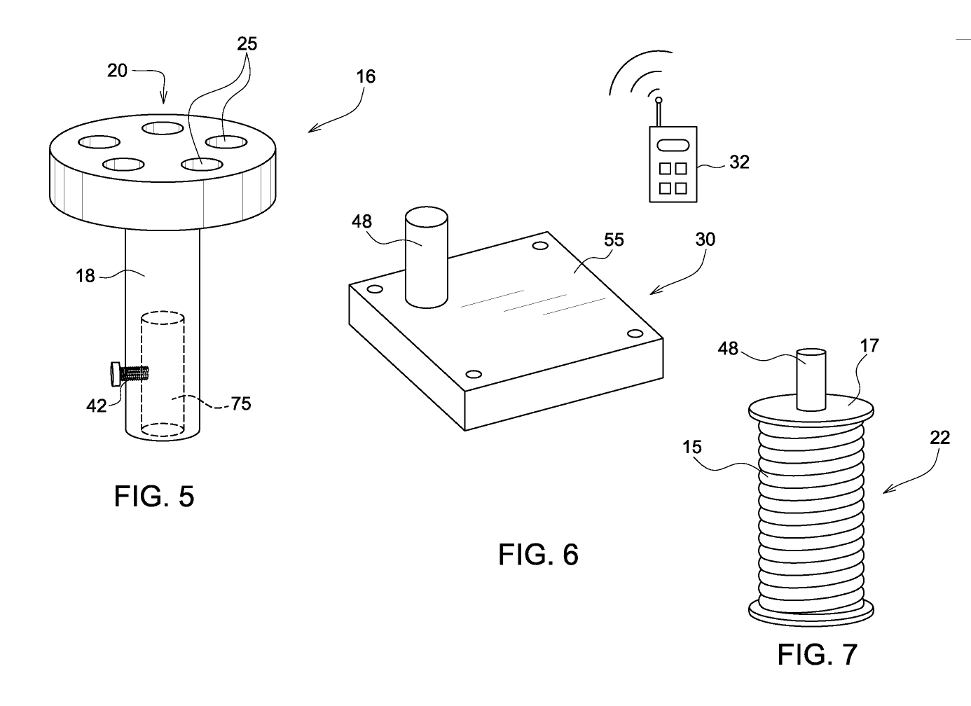

FIG. 5 illustrates a perspective view of a hub of a decoy apparatus, according to one embodiment of the invention. There is shown a hub 16 including an axle 18 and a mounting face 20.

The illustrated hub 16 includes an axle 18 configured to extend through a base member of a decoy apparatus. The axle 18 includes an interior cavity 75 disposed therein, and configured to couple to a spool or a motor module. The hub 16 includes a mounting face 20 disposed above the axle 18 and configured to couple to a plurality of arms of a decoy apparatus. The mounting face 20 includes a plurality of apertures 25 configured to receive a plurality of arms of the decoy apparatus. The mounting face 20 is configured to support a plurality of arms extending out therefrom. The axle 18 is configured to rotate upon manipulation of a spool or a motor module, thereby rotating the mounting face 20 and the plurality of arms attached thereto. The axle 18 includes a securing member 42 (pinning screw) disposed within an internal cavity 75 and configured to secure to another structure, including but not limited to another axle, a spool, or a motor module thereto such that rotation of the axle may be synchronous with rotation of an attached structure or device.

FIG. 6 illustrates a perspective view of a motor module and a remote control module of a decoy apparatus, according to one embodiment of the invention. There is shown a motor module 30 including a remote control module 32, a motor housing 55 and an attachment arm 48. The motor housing 55 includes a plurality of apertures that may match up with similar apertures of a base plate such that the motor may be coupled to an underside thereto such as by but not limited to using screws and/or bolts.

The illustrated motor module 30 is configured to provide selectably motorized movement of a hub 16 of a decoy apparatus, thereby providing motorized movement to a plurality of arms coupled to the hub 16. The motor module 30 is configured to couple to an axle of a hub and configured to provide motorized movement thereto. The motor module 30 includes a motor housing 55 configured to support and enclose the modules and components of the motor module 30. The motor module 30 includes a motor configured to provide motorized movement to an attachment arm 48. The motor module includes a communication module configured to receive wireless communication thereto. The motor module 30 is configured to be disposed underneath a base member and configured to provide selectable motorized movement of a hub of a decoy apparatus.

The motor module 30 includes a remote control module 32 in wireless communication with the motor module 30. The remote control module includes a wireless transmitter configured to activate the motor module 30 from signals sent from a remote location. The motor module 30 includes a power module (not shown) disposed within the motor housing 55 and configured to provide power to the motor module 30 and the components thereof. The motor module 30 includes an attachment arm 48 configured to couple to an axle of a hub, such as but not limited to the cavity 75 and pinning screw 42 of FIG. 5. The attachment arm 48 is disposed on a top surface of the motor housing 55 and configured to extend upwardly therefrom. The illustrated attachment member 48 is sized and shaped to fit within an internal cavity of an axle and secure thereto.

FIG. 7 illustrates a perspective view of a spool of a decoy apparatus, according to one embodiment of the invention. There is shown a spool 22 including a length of cord 15, a cord housing 17 framed by flanges, and an attachment member 48.

The illustrated spool 22 is configured to selectably couple to an axle of a hub of a decoy apparatus. The spool 22 is sized and shaped to be able to be disposed underneath a base member of the decoy apparatus without obstructing the operation of a plurality of leg mounting ports and a plurality of leg members coupled thereto. The spool 22 includes a cord housing 17 configured to store and secure to a length of cord 15. The length of cord 15 is configured to be wound about the cord housing, thereby securing thereto. The spool 22 includes an attachment member 48 disposed on a top surface of the cord housing 17 and configured to couple to an axle of a hub of the decoy apparatus. The attachment member 48 is sized and shaped to fit within an internal cavity of an axle and secure thereto.

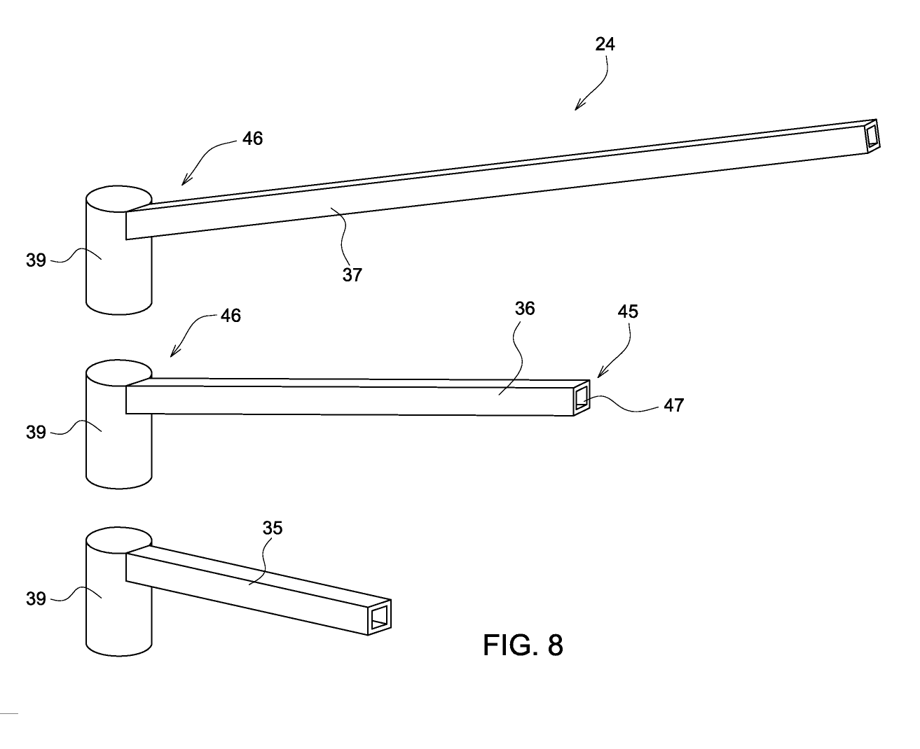

FIG. 8 illustrates a perspective view of a plurality of arms of a decoy apparatus, according to one embodiment of the invention. There is shown a plurality of arms 24 including an attachment end 39, and an arm member 36 having an angled extension arm 46.

The illustrated plurality of arms include cylindrical posts coupled to rectangular hollow members extending outwardly therefrom at a predetermined angle. The arms are configured to be selectably coupleable to a mounting face of a hub of a decoy apparatus and accordingly the shape, size and orientation of the cylindrical posts match with and/or mate with similar structures of the mounting face. The plurality of arms are oriented, sized and shaped to extend outwardly from the mounting face when so attached. The plurality of arms 24 include modular components configured to be interchangeable, and including varying lengths to provide a balanced decoy apparatus during use. The illustrated arms 24 include a small extension 35, a medium extension 36, and a large extension 37. Each extension includes a receiving member/structure/aperture 47 disposed about an end 45 and configured to receive an attachment end of another extension arm. The plurality of arms 24 include a plurality of selectably connectable arm segments of varying length. The plurality of arms 24 each include an angled extension arm 46 configured to couple to the mounting face of the hub. The angled extension arm 46 is oriented at an angle substantially different from an angle of another extension arm of the apparatus. The longer the extension arm, the more angled the angled extension arm 46. The small extension 35 includes a slight angle, the medium extension 36 includes a greater angle then the small extension 35, and the large extension 37 includes a greater angle then the medium extension 36. The angled extension arm 46 is configured to increase in angle to provide support for decoys positioned further away from a hub.

As a non-limiting example, there may be a set of extension arms wherein an angular difference between the arms may be proportional to length differences between the arms. As another non-limiting example, there may be a set of extension arms wherein angles of the arms may be calculated to be substantially equal to or greater than an expected bending of an extension arm, such that arms of different lengths a functional equivalents with respect to holding decoys of a particular weight range off the ground.

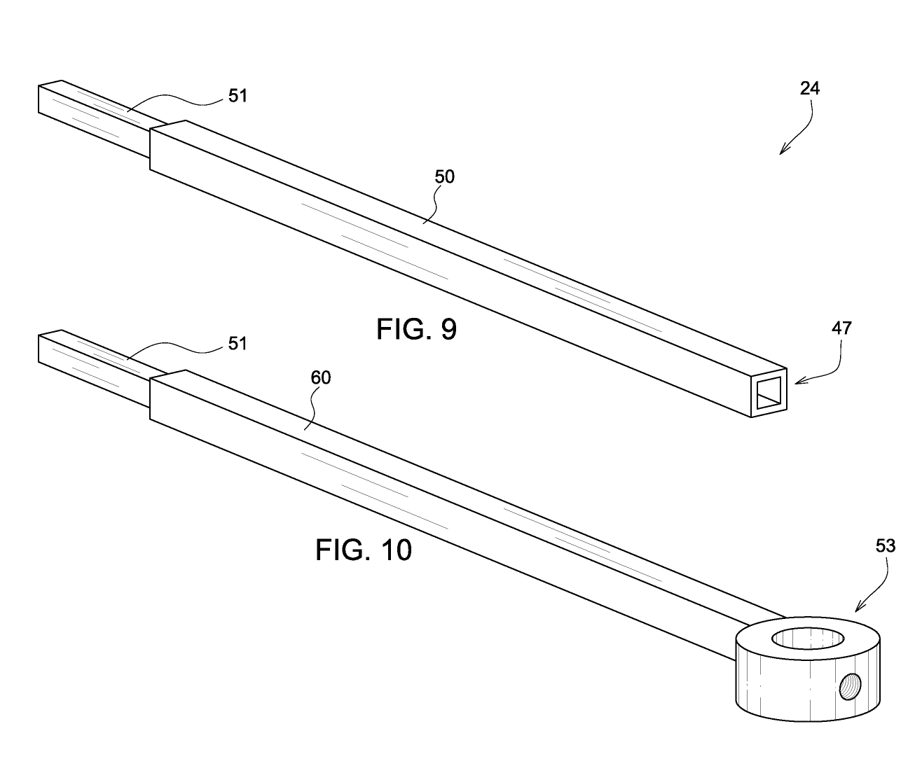

FIG. 9 illustrates a perspective view of an extension arm of a decoy apparatus, according to one embodiment of the invention. There is shown an extension arm 24 including a receiving member 47 and an attachment member 51.

The illustrated extension arm 24 is configured to provide extended length to a decoy apparatus. The extension arm 24 includes an attachment member 51 sized and shaped to couple to a receiving member of another extension arm. The attachment member is sized and shaped to be inserted into a receiving member and securely couple thereto. The extension arm 24 includes a receiving member 47 disposed about an end, opposite of the attachment member 51. The receiving member 47 is configured to receive an attachment member of another extension arm. The receiving member is sized and shaped to receive an attachment member and securely couple thereto. The extension arm 24 includes a body member 50 configured to extend and couple the attachment member 51 to the receiving member 47.

FIG. 10 illustrates a perspective view of a coupling arm of a decoy apparatus, according to one embodiment of the invention. There is shown an extension arm 24 including an attachment member 51 and a coupling end 53.

The illustrated extension arm 24 is configured to couple to a cradle or to a decoy of a decoy apparatus. The extension arm 24 includes an attachment member 51 sized and shaped to couple to a receiving member of another extension arm. The attachment member is sized and shaped to be inserted into a receiving member and securely couple thereto. The extension arm 24 includes a coupling end 53 configured to couple to a cradle or to a decoy of a decoy apparatus. The coupling end 53 includes an aperture configured to receive a decoy rod or a cradle to couple a decoy thereto. The extension arm 24 includes a body member 60 configured to extend and couple the attachment member 51 to the coupling end 53.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a particular number and configuration of arms and legs, it is understood that the invention is not limited to the specific number of each illustrated.

Additionally, although the figures illustrate separable legs/arms etc., in one non-limiting embodiment one or more of the arms/legs, etc. may fold over on itself instead of separating. More, while particular coupling devices are illustrated, it is understood that the types of coupling devices and/or structures that may be employed in various embodiments are plethoric.

Also, while particular decoys are illustrated, it is understood that the types, configurations, styles, and subject matter associated with the decoys that are usable with this system are plethoric and may include any decoy of any animal of any size, shape, color, configuration or the like that may be disposed on, over, or otherwise functionally coupled to the system.

It is envisioned that, one skilled in the art would appreciate that the motor module may include an audio module configured to mimic the sounds of wild game. The audio module may include a plurality of wild game sounds configured to attract and lure wild game towards the decoy apparatus, and still perform its intended function.

It is expected that there could be numerous variations of the design of this invention. An example is that the entire device may be unitary and a single folding piece such that when it is broken down it folds on itself to become compact for storage and transport. In one non-limiting example of such, sections that separate may be coupled together with an elastic cord, much like with tent poles where the core of each pole includes a channel through which an elastic cord extends coupling each pole to the next. In another non-limiting example, adjacent sections may be coupled by a hinge that permits such sections to be selectably folded on each other. Such hinges may include devices and/or structures for locking sections in place (folded or straightened or both) such as but not limited to snaps, stays, bias members that snap into recesses and the like and combinations thereof.

Finally, it is envisioned that the components of the device may be constructed of a variety of materials, including but not limited to metals, plastics, rubbers, ceramics, fibers, wood, composite materials, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A decoy apparatus configured to simulate the movement of wild game, comprising:
a) a base member including a plurality of leg mounting ports;
b) a hub disposed above the base member and extending therethrough, including:
b1) an axle extending through and below the base member;
b2) a mounting face coupled to the axle and disposed above the base member;
c) a spool coupled to the axle of the hub and disposed underneath the base member;
d) a plurality of arms coupled to the mounting face of the hub and extending outwardly therefrom;
e) a plurality of decoys coupled to an end of the plurality of arms and configured to resemble live wild game; and
f) a plurality of leg members coupled to the plurality of leg mounting ports of the base member.

2. The apparatus of claim 1, further comprising a motor module coupled to the axle of the hub and disposed underneath the base member and configured to provide selectable motorized movement of the hub.

3. The apparatus of claim 2, wherein the motor module further comprises a remote control module including a wireless transmitter configured to activate the motor module from signals sent from a remote location.

4. The apparatus of claim 2, wherein the motor module further comprises a power module configured to provide power thereto.

5. The apparatus of claim 1, wherein one of the plurality of arms includes a plurality of selectably connectable arm segments of varying length.

6. The apparatus of claim 1, further comprising a wild game cradle selectably coupled to one of the plurality of arms and configured to support a decoy thereon.

7. The apparatus of claim 1, further comprising a plurality of stakes selectably coupleable to the plurality of leg members and configured to couple the plurality of leg members to the ground.

8. The apparatus of claim 1, wherein the axle further comprises a securing member disposed therein and configured to securely couple the spool thereto.

9. The apparatus of claim 1, further comprising a plurality of guide members coupled to a length of cord at least partially wound about the spool and configured to guide a length of cord from the spool away from the decoy apparatus.

10. The apparatus of claim 1, wherein the plurality of arms each include an angled extension arm coupled to the mounting face of the hub, wherein the angled extension arm is oriented at an angle substantially different from an angle of another extension arm of the apparatus.

11. A decoy kit configured to simulate the movement of wild game, comprising:
a) a base member including a plurality of leg mounting ports;
b) a hub disposed above the base member and shaped and sized to be able to extend therethrough, including:
b1) an axle;
b2) a mounting face coupled to the axle;
c) a spool selectably coupleable to the axle of the hub and sized to be able to be disposed underneath the base member without obstructing the operation of the leg mounting ports thereof; wherein the axle further comprises a securing member disposed therein and configured to securely couple the spool thereto;
d) a plurality of arms selectably coupleable to the mounting face of the hub and shaped to extend outwardly therefrom when so attached;
e) a plurality of decoys selectably coupleable to an end of the plurality of arms and configured to resemble live wild game;
f) a plurality of leg members configured to couple to the plurality of leg mounting ports of the base member; and
g) a plurality of wild game cradles configured to support the plurality of decoys when coupled to the plurality of arms.

12. The kit of claim 11, further comprising a motor module coupled to the axle of the hub and disposed underneath the base member and configured to provide selectable motorized movement of the hub.

13. The kit of claim 12, wherein the motor module further comprises a remote control module including a wireless transmitter configured to activate the motor module from signals sent from a remote location.

14. The kit of claim 13, wherein the motor module further comprises a power module configured to provide power thereto.

15. The kit of claim 14, wherein one of the plurality of arms includes a plurality of selectably connectable arm segments of varying length.

16. The kit of claim 15, further comprising a plurality of stakes selectably coupleable to the plurality of leg members and configured to couple the plurality of leg members to the ground.

17. The kit of claim 16, further comprising a plurality of guide members coupled to a length of cord at least partially wound about the spool and configured guide a length of cord from the spool away from the decoy apparatus.

18. The kit of claim 17, wherein the plurality of arms each include an angled extension arm coupled to the mounting face of the hub, wherein the angled extension arm is oriented at an angle substantially different from an angle of another extension arm of the apparatus.

19. A decoy kit configured to simulate the movement of wild game, comprising:
a) a base member including a plurality of leg mounting ports;
b) a hub disposed above the base member and shaped and sized to be able to extend therethrough, including:
b1) an axle extending through and below the base member;
b2) a mounting face coupled to the axle and disposed above the base member;
c) a spool selectably coupleable to the axle of the hub and sized to be able to be disposed underneath the base member without obstructing the operation of the leg mounting ports thereof; wherein the axle further comprises a securing member disposed therein and configured to securely couple the spool thereto;
d) a plurality of arms selectably coupleable to the mounting face of the hub and shaped to extend outwardly therefrom when so attached; wherein one of the plurality of arms includes a plurality of selectably connectable arm segments of varying length; wherein the plurality of arms each include an angled extension arm coupled to the mounting face of the hub, wherein the angled extension arm is oriented at an angle substantially different from an angle of another extension arm of the apparatus;
e) a plurality of decoys selectably coupleable to an end of the plurality of arms and configured to resemble live wild game;
f) a plurality of leg members configured to couple to the plurality of leg mounting ports of the base member; and
g) a wild game cradle selectably coupled to one of the plurality of arms and configured to support a decoy;
h) a plurality of stakes selectably coupleable to the plurality of leg members and configured to couple the plurality of leg members to the ground; and
i) a plurality of guide members coupled to a length of cord at least partially wound about the spool and configured to guide a length of cord from the spool away from the decoy apparatus.

20. The kit of claim 19, further comprising: a motor module coupled to the axle of the hub and disposed underneath the base member and configured to provide selectable motorized movement of the hub; wherein the motor module further comprises a remote control module including a wireless transmitter configured to activate the motor module from signals sent from a remote location; wherein the motor module further comprises a power module configured to provide power thereto.
